(19) United States
(12) Patent Application Publication
(10) Pub. No.: US 2012/0305836 A1
(43) Pub. Date: Dec. 6, 2012

(54) METHODS AND CATALYSTS FOR DEOXYGENATING BIOMASS-DERIVED PYROLYSIS OIL

(75) Inventors: Thomas Traynor, Buffalo Grove, IL (US); Timothy A. Brandvold, Arlington Heights, IL (US); Jennifer F. Abrahamian, Chicago, IL (US)

(73) Assignee: UOP LLC, Des Plaines, IL (US)

(21) Appl. No.: 13/150,844

(22) Filed: Jun. 1, 2011

(51) Int. Cl. B01J 23/889; C09K 3/00

(52) U.S. Cl. 252/182.12; 502/324

(57) ABSTRACT

Embodiments of methods and catalysts for deoxygenating a biomass-derived pyrolysis oil are provided. The method comprises the step of contacting the biomass-derived pyrolysis oil with a first deoxygenating catalyst in the presence of hydrogen at first predetermined hydroprocessing conditions to form a first low-oxygen biomass-derived pyrolysis oil effluent. The first deoxygenating catalyst comprises a neutral catalyst support, nickel, cobalt, and molybdenum. The first deoxygenating catalyst comprises nickel in an amount calculated as an oxide of from about 0.1 to about 1.5 wt. %.

### FIELD OF THE INVENTION

The present invention relates generally to methods and catalysts for producing biofuels, and more particularly to methods and catalysts for producing low-oxygen biomass-derived pyrolysis oil from the catalytic deoxygenation of biomass-derived pyrolysis oil.

### BACKGROUND OF THE INVENTION

Fast paralysis is a process during which organic carbonaceous biomass feedstock, i.e., “biomass”, such as wood waste, agricultural waste, algae, etc., is rapidly heated to between about 300° C. to about 900° C. in the absence of air using a pyrolysis reactor. Under these conditions, solid products, liquid products, and gaseous pyrolysis products are produced. A condensable portion (vapors) of the gaseous pyrolysis products is condensed into biomass-derived pyrolysis oil. Biomass-derived pyrolysis oil can be burned directly as fuel for certain boiler and furnace applications, and can also serve as a potential feedstock in catalytic processes for the production of fuels in petroleum refineries. Biomass-derived pyrolysis oil has the potential to replace up to 60% of transportation fuels, thereby reducing the dependency on conventional petroleum and reducing its environmental impact.

However, biomass-derived pyrolysis oil is a complex, highly oxygenated organic liquid having properties that currently limit its utilization as a biofuel. For example, biomass-derived pyrolysis oil has high acidity and a low energy density attributable in large part to oxygenated hydrocarbons in the oil, which undergo secondary reactions during storage. “Oxygenated hydrocarbons” as used herein are organic compounds containing hydrogen, carbon, and oxygen. Such oxygenated hydrocarbons in the biomass-derived pyrolysis oil include carboxylic acids, phenols, cresols, alcohols, aldehydes, etc. Conventional biomass-derived pyrolysis oil comprises about 30% by weight oxygen from these oxygenated hydrocarbons. Conversion of biomass-derived pyrolysis oil into biofuels and chemicals requires full or partial deoxygenation of the biomass-derived pyrolysis oil. Such deoxygenation may proceed via two main routes, namely the elimination of either water or CO₂. Unfortunately, deoxygenating biomass-derived pyrolysis oil leads to rapid plugging or fouling of the processing catalyst in a hydroprocessing reactor caused by the formation of solids from the biomass-derived pyrolysis oil. Components in the pyrolysis oil form on the processing catalysts causing catalytic bed fouling, reducing activity of the catalyst and causing build up in the hydroprocessing reactor. It is believed that this plugging is due to an acid catalyzed polymerization of the various components of the biomass-derived pyrolysis oil that create either a glassy brown polymer or powdery brown char, which limit run duration and processibility of the biomass-derived pyrolysis oil.

Accordingly, it is desirable to provide methods and catalysts for producing low-oxygen biomass-derived pyrolysis oils. In addition, it is also desirable to produce low-oxygen biomass-derived pyrolysis oils without plugging of the catalyst contained in a reactor, thereby increasing run duration and improving processibility of the biomass-derived pyrolysis oil. Furthermore, other desirable features and characteristics of the present invention will become apparent from the subsequent detailed description of the invention and the appended claims, taken in conjunction with the accompanying drawings and this background of the invention.

### SUMMARY OF THE INVENTION

Methods and catalysts for deoxygenating a biomass-derived pyrolysis oil are provided herein. In accordance with an exemplary embodiment, a method for deoxygenating a biomass-derived pyrolysis oil comprises the step of contacting the biomass-derived pyrolysis oil with a first deoxygenating catalyst in the presence of hydrogen at first predetermined hydroprocessing conditions to form a first low-oxygen biomass-derived pyrolysis oil effluent. The first deoxygenating catalyst comprises a neutral catalyst support, nickel, cobalt, and molybdenum. The first deoxygenating catalyst comprises nickel in an amount calculated as an oxide of from about 0.1 to about 1.5 wt. %.

In accordance with another exemplary embodiment, a method for deoxygenating a biomass-derived pyrolysis oil is provided. The method comprises the step of introducing hydrogen and a feed stream comprising the biomass-derived pyrolysis oil to a first hydroprocessing reactor containing a first deoxygenating catalyst. The first hydroprocessing reactor is operating at first predetermined hydroprocessing conditions to form a first low-oxygen biomass-derived pyrolysis oil effluent. The first deoxygenating catalyst comprises a neutral catalyst support, nickel, cobalt, and molybdenum. The first deoxygenating catalyst comprises nickel in an amount calculated as an oxide of from about 0.1 to about 1.5 wt. %, cobalt in an amount calculated as an oxide of from about 2 to about 4 wt. %, molybdenum in an amount calculated as an oxide of from about 10 to about 20 wt. %. The neutral catalyst support is selected from the group consisting of a titanium oxide (TiO₂) support, a zirconium oxide (ZrO₂) support, a niobium oxide (Nb₂O₅) support, a theta alumina support, and combinations thereof.

In accordance with another exemplary embodiment, a catalyst for deoxygenating a biomass-derived pyrolysis oil is provided. The catalyst comprises a neutral catalyst support, nickel, cobalt, and molybdenum. Nickel is in an amount calculated as an oxide of from about 0.1 to about 1.5 wt. %, cobalt is in an amount calculated as an oxide of from about 2 to about 4 wt. %, molybdenum is in an amount calculated as an oxide of from about 10 to about 20 wt. %. The neutral catalyst support is selected from the group consisting of a titanium oxide (TiO₂) support, a zirconium oxide (ZrO₂) support, a niobium oxide (Nb₂O₅) support, a theta alumina support, and combinations thereof.

### BRIEF DESCRIPTION OF THE DRAWINGS

Embodiments of the present invention will hereinafter be described in conjunction with the following drawing figures, wherein like numerals denote like elements, and wherein:

FIG. 1 schematically illustrates an apparatus for deoxygenating a biomass-derived pyrolysis oil in accordance with an exemplary embodiment.

### DETAILED DESCRIPTION

The following Detailed Description is merely exemplary in nature and is not intended to limit the invention or the application and uses of the invention. Furthermore, there is no intention to be bound by any theory presented in the preceding Background of the Invention or the following Detailed Description.

Various embodiments contemplated herein relate to methods and catalysts for deoxygenating a biomass-derived pyrolysis oil. Unlike the prior art, the exemplary embodiments taught herein produce a low-oxygen biomass-derived pyrolysis oil by contacting a biomass-derived pyrolysis oil with a deoxygenating catalyst in the presence of hydrogen at predetermined hydroprocessing conditions. The deoxygenating catalyst comprises a neutral catalyst support, cobalt, molybdenum and a small amount of nickel that are disposed on the neutral catalyst support. The inventors have found that the neutral catalyst support is stable and resistant dissolving over time in the biomass-derived pyrolysis oil, which typically has a high water content, and therefore provides a robust and durable support for the catalytically active metals of cobalt, molybdenum, and nickel. Moreover, the neutral catalyst support does not promote acid catalyzed polymerization of the various components of the biomass-derived pyrolysis oil that otherwise cause catalyst plugging. Furthermore, the inventors have found that the catalyst activity of cobalt-molybdenum, which is relatively low but resist catalyst plugging, can be selectively increased with the addition of a small amount of nickel to effectively deoxygenate biomass-derived pyrolysis oil without increasing the catalyst activity to the extent of causing the catalyst to plug.

It should be appreciated that while the deoxygenated oil produced according to exemplary embodiments of the present invention is generally described herein as a “low-oxygen biomass-derived pyrolysis oil,” this term generally includes any oil produced having a lower oxygen concentration than conventional biomass-derived pyrolysis oil. The term “low-oxygen biomass-derived pyrolysis oil” includes oil having no oxygen, i.e., a biomass-derived pyrolysis oil in which all the oxygenated hydrocarbons have been converted into hydrocarbons (i.e., a “hydrocarbon product”). Preferably, the low-oxygen biomass-derived pyrolysis oil comprises oxygen in an amount of from about 0 to about 5 weight percent (wt. %). “Hydrocarbons” as used herein are organic compounds that contain principally only hydrogen and carbon, i.e., oxygen-free. “Oxygenated hydrocarbons” as used herein are organic compounds containing hydrogen, carbon, and oxygen. Exemplary oxygenated hydrocarbons in biomass-derived pyrolysis oil include alcohols such as phenols and cresols, carboxylic acids, alcohols, aldehydes, etc.

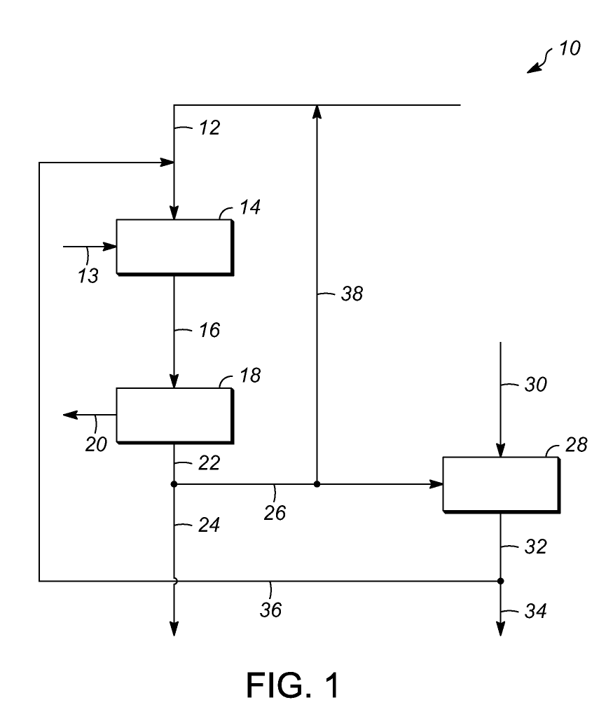

Referring to FIG. 1, a schematic depiction of an apparatus 10 for deoxygenating a biomass-derived pyrolysis oil in accordance with an exemplary embodiment is provided. A feed stream 12 containing a biomass-derived pyrolysis oil and a hydrogen-containing gas 13 are introduced to a first hydroprocessing reactor 14. The biomass-derived pyrolysis oil may be produced, such as, for example, from pyrolysis of biomass in a pyrolysis reactor. Virtually any form of biomass can be used for pyrolysis to produce a biomass-derived pyrolysis oil. The biomass-derived pyrolysis oil may be derived from biomass material, such as, wood, agricultural waste, nuts and seeds, algae, forestry residues, and the like. The biomass-derived pyrolysis oil may be obtained by different modes of pyrolysis, such as, for example, fast pyrolysis, vacuum pyrolysis, catalytic pyrolysis, and slow pyrolysis or carbonization, and the like. The composition of the biomass-derived pyrolysis oil can vary considerably and depends on the feedstock and processing variables. Examples of biomass-derived pyrolysis oil “as-produced” can contain up to about 1000 to about 2000 ppm total metals, about 20 to about 33 wt. % of water that can have high acidity (e.g. total acid number (TAN)>150), and a solids content of about 0.1 wt. % to about 5 wt. %. The biomass-derived pyrolysis oil may be untreated (e.g. “as produced”). However, if needed the biomass-derived pyrolysis oil can be selectively treated to reduce any or all of the above to a desired level.

The first hydroprocessing reactor 14 contains a first deoxygenating catalyst. In an exemplary embodiment, the first deoxygenating catalyst comprises a neutral catalyst support. As used herein, a “neutral catalyst support” is defined as one that shows less than 15% total conversion of 1-heptene in a catalytic test reactor as follows: 0.25 g of solid support material (ground and sieved to 40/60 mesh) is loaded in a tubular reactor and heated under flowing hydrogen (1 atmosphere, upflow) to 550° C. for 60 minutes. The reactor is cooled to 425° C., hydrogen flow rate is set at 1 slm (standard liter per minute), and 1-heptene is introduced to the catalyst bed (by injection into or saturation of the hydrogen stream) at a rate of ˜0.085 g/min. Conversion of 1-heptene is defined by 100*(1−X(heptene)) where X is the mole fraction of 1-heptene in the hydrocarbon product as determined by gas chromatographic analysis of the reactor effluent stream. Various options for gas chromatographic analysis as known in the art may be used, and other analytical methods known in the art may be substituted for gas chromatographic analysis as long as a mole fraction of n-heptene in the product may be calculated. Preferably, the neutral catalyst support comprises a titanium oxide (TiO₂) support, a zirconium oxide (ZrO₂) support, a niobium oxide (Nb₂O₅) support, a theta alumina support, or combinations thereof, and more preferably comprises a titanium oxide (TiO₂) support or a zirconium oxide (ZrO₂) support. The non-alumina metal oxide supports can be mixed with one or more additional components to improve the physical stability and/or phase stability of the metal oxide. Components that improve physical stability include, but are not limited to, carbon, other metal oxides, and clays as known in the art. Components that improve phase stability include, but are not limited to, base metals, transition metals, non-metals, lanthanide metals, and combinations thereof. “Theta alumina” as used herein refers to alumina having a crystallinity as measured by X-ray diffraction corresponding to that characterized in the Joint Committee on Powder Diffraction Standards number 23-1009.

The first deoxygenating catalyst also comprises metals disposed on the neutral catalyst support. The metals are nickel, cobalt, and molybdenum. In an exemplary embodiment, nickel is present in an amount calculated as an oxide of from about 0.1 to about 1.5 wt. %, and preferably from about 0.5 to about 1.0 wt. % of the first deoxygenating catalyst. Cobalt is present in an amount calculated as an oxide of from about 2 to about 4 wt. %, and preferably about 3 wt. % of the first deoxygenating catalyst. Molybdenum is present in an amount calculated as an oxide of from about 10 to about 20 wt. %, and preferably about 15 wt. % of the first deoxygenating catalyst. The term “calculated as an oxide” means that the metal is calculated as a metal oxide. When metals are initially incorporated onto the neutral catalyst support, they may be present as a metal oxide, rather than in the metallic state. Therefore, as used herein, if the metal is “calculated as an oxide,” that means the catalyst has x % metal oxide. The actual amount of the metal will be somewhat lower depending on the stoichiometry of a specific oxide. The oxide is removed during deoxygenation leaving the metallic form of the metal on the neutral catalyst support.

The first hydroprocessing reactor 14 may be, for example, a batch reactor or a continuous flow reactor, such as, an upflow or downflow tubular reactor with or without a fixed catalyst bed, a continuously stirred reactor, and the like. Other reactors known to those skilled in the art for catalytic hydroprocessing of an oil-based feedstock may also be used. In an exemplary embodiment, the first hydroprocessing reactor 14 is operating at first predetermined hydroprocessing conditions including a reaction temperature of from about 100° C. to about 400° C., a pressure of from about 3200 kPa to about 12400 kPa (about 450 to about 1800 psig), a liquid hourly space velocity of from about 0.25 volume of liquid feed/volume of catalyst/hour (Hr⁻¹) to about 1.0 Hr⁻¹, and a hydrogen-containing gas treat rate of about 1000 SCF/B to about 12000 SCF/B.

The biomass-derived pyrolysis oil contained in the feed stream 12 contacts the first deoxygenating catalyst at the first predetermined hydroprocessing conditions in the presence of hydrogen to form a first low-oxygen biomass-derived pyrolysis oil effluent 16 by converting at least a portion of the oxygenated hydrocarbons in the biomass-derived pyrolysis oil into hydrocarbons. In particular, hydrogen from the hydrogen-containing gas 13 removes oxygen from the biomass-derived pyrolysis oil as water, thereby producing the low-oxygen biomass-derived pyrolysis oil effluent 16. The oil contained in the low-oxygen biomass-derived pyrolysis oil effluent 16 may be partially deoxygenated with some residual oxygenated hydrocarbons, or may be substantially fully deoxygenated where substantially all of the oxygenated hydrocarbons are converted into hydrocarbons.

The low-oxygen biomass-derived pyrolysis oil effluent 16 is removed from the first hydroprocessing reactor 14 and pass along to a separation unit 18 to remove water 20 and form a water-depleted low-oxygen biomass-derived pyrolysis oil effluent 22. The water-depleted low-oxygen biomass-derived pyrolysis oil effluent 22 may be removed from the apparatus 10 along line 24 (e.g. if substantially fully deoxygenated) or alternatively, at least a portion of the water-depleted low-oxygen biomass-derived pyrolysis oil effluent 22 may be directed along line 26.

In an exemplary embodiment, at least a portion of the water-depleted low-oxygen biomass-derived pyrolysis oil effluent 22 is passed along line 26 and introduced to a second hydroprocessing reactor 28. The water-depleted low-oxygen biomass-derived pyrolysis oil effluent 22 is exposed to a second deoxygenating catalyst in the presence of an additional hydrogen-containing gas 30 at second predetermined hydroprocessing conditions in the second hydroprocessing reactor 28 to convert any residual oxygenated hydrocarbons in the effluent 22 into hydrocarbons and form a second low-oxygen biomass-derived pyrolysis oil effluent 32. Preferably, the second low-oxygen biomass-derived pyrolysis oil effluent 32 is substantially fully deoxygenated, i.e., oxygen-free. The second deoxygenating catalyst may be a conventional hydroprocessing catalyst such as nickel and molybdenum on a gamma alumina support or others well known in the art, or alternatively may have a similar composition to the first deoxygenating catalyst. The second predetermined hydroprocessing conditions include a reaction temperature of from about 300° C. to about 350° C., a pressure of from about 3550 kPa to about 12400 kPa (500 psig to about 1800 psig), a liquid hourly space velocity of from about 0.5 Hr⁻¹ to about 1.5 Hr⁻¹, and a hydrogen-containing gas treat rate of about 400 SCF/B to about 8000 SCF/B. The second hydroprocessing reactor 28 may be a reactor such as a fixed bed tubular reactor, a stir tank reactor, and the like.

The minimum total amount of hydrogen-containing gas 13 and/or additional hydrogen-containing gas 30 needed to convert substantially all of the oxygenated hydrocarbons of the biomass-derived pyrolysis oil contained in the feed stream 12 comprises 1-2 equivalents of hydrogen-containing gas per one equivalent of non-water oxygen. The non-water oxygen in the biomass-derived pyrolysis oil is derived from the functional groups of the oxygenated hydrocarbons therein. For example, one equivalent of an alcohol functional group and a ketone functional group requires 1 equivalent of hydrogen-containing gas for deoxygenation whereas one equivalent of an ester functional group requires 2 equivalents of hydrogen-containing gas, and 1 equivalent of a carboxylic acid functional group requires 1.5 equivalents of hydrogen-containing gas. Therefore, for example, the more esters and carboxylic acids present in the biomass-derived pyrolysis oil, the more hydrogen-containing gas is necessary for conversion of all the oxygenated hydrocarbons therein into hydrocarbons. The minimum amount of hydrogen-containing gas to substantially deoxygenate the biomass-derived pyrolysis oil is equal to about one to about three molar equivalents of the non-water oxygen therein. The amount of non-water oxygen=A−B wherein A is the total amount of oxygen in the biomass-derived pyrolysis oil as determined by a combustion method that is well known in the art, and B is the total amount of oxygen in the water in the biomass-derived pyrolysis oil. To determine B, the total water content in the biomass-derived pyrolysis oil is first determined by the Karl Fischer Reagent Titration Method (ASTM D1364) as known to one skilled in the art. An excess of hydrogen-containing gas 13 and/or 30 may also be used.

The second low-oxygen biomass-derived pyrolysis oil effluent 32 can be removed from the apparatus 10 along line 34. In at least one exemplary embodiment, at least a portion of the water-depleted low-oxygen biomass-derived pyrolysis oil effluent 22 and/or at least a portion of the second low-oxygen biomass-derived pyrolysis oil effluent 32 are recycled in the apparatus 10 by being directed to the feed stream 12. In one example, at least a portion of the water-depleted low-oxygen biomass-derived pyrolysis oil effluent 22 is passed along line 38 and introduced to the feed stream 12 upstream of the first hydroprocessing reactor 14. In another example, the second low-oxygen biomass-derived pyrolysis oil effluent 32 is passed along line 36 and introduced to the feed stream 12 upstream of the first hydroprocessing reactor 14. Recycling at least a portion of the water-depleted low-oxygen biomass-derived pyrolysis oil effluent 22 and/or the second low-oxygen biomass-derived pyrolysis oil effluent 32 helps control the temperature of the highly exothermic deoxygenation reaction in the first hydroprocessing reactor 14. The benefits of recycling at least a portion of either of these effluents 22 and/or 32 include, but are not limited, increasing hydrogen solubility, immolation of the exotherm by dilution of the reactive species, and reducing the reaction rate of bimolecular reactants that lead to plugging of the catalyst. The preferred ratio of the recycled water-depleted low-oxygen biomass-derived pyrolysis oil effluent 22 and/or the recycled second low-oxygen biomass-derived pyrolysis oil effluent 32 comprises a ratio of from about 1.5:1 to about 5:1.

Accordingly, methods and catalysts for deoxygenating a biomass-derived pyrolysis oil have been described. Unlike the prior art, the exemplary embodiments taught herein produce a low-oxygen biomass-derived pyrolysis oil by contacting a biomass-derived pyrolysis oil with a deoxygenating catalyst in the presence of hydrogen at predetermined hydroprocessing conditions. The deoxygenating catalyst comprises a neutral catalyst support, cobalt, molybdenum and a small amount of nickel that are disposed on the neutral catalyst support. The neutral catalyst support is stable and resistant dissolving over time in the biomass-derived pyrolysis oil, which typically has a high water content, and therefore provides a robust and durable support for the catalytically active metals of cobalt, molybdenum, and nickel. Moreover, the neutral catalyst support does not promote acid catalyzed polymerization of the various components of the biomass-derived pyrolysis oil that otherwise cause catalyst plugging. Furthermore, the catalyst activity of cobalt-molybdenum, which is relatively low but resist catalyst plugging, can be selectively increased with the addition of a small amount of nickel to effectively deoxygenate biomass-derived pyrolysis oil without increasing the catalyst activity to the extent of causing the catalyst to plug.

While at least one exemplary embodiment has been presented in the foregoing Detailed Description, it should be appreciated that a vast number of variations exist. It should also be appreciated that the exemplary embodiment or exemplary embodiments are only examples, and are not intended to limit the scope, applicability, or configuration of the invention in any way. Rather, the foregoing Detailed Description will provide those skilled in the art with a convenient road map for implementing an exemplary embodiment of the invention, it being understood that various changes may be made in the function and arrangement of elements described in an exemplary embodiment without departing from the scope of the invention as set forth in the appended Claims and their legal equivalents.

What is claimed is:

1. A method for deoxygenating a biomass-derived pyrolysis oil, the method comprising the step of:
contacting the biomass-derived pyrolysis oil with a first deoxygenating catalyst in the presence of hydrogen at first predetermined hydroprocessing conditions to form a first low-oxygen biomass-derived pyrolysis oil effluent, wherein the first deoxygenating catalyst comprises a neutral catalyst support, nickel, cobalt, and molybdenum, and wherein the first deoxygenating catalyst comprises nickel in an amount calculated as an oxide of from about 0.1 to about 1.5 wt. %.

2. The method according to claim 1, wherein the step of contacting includes contacting the biomass-derived pyrolysis oil with the first deoxygenating catalyst that comprises nickel in an amount calculated as an oxide of from about 0.5 to about 1 wt. %.

3. The method according to claim 1, wherein the step of contacting includes contacting the biomass-derived pyrolysis oil with the first deoxygenating catalyst that comprises cobalt in an amount calculated as an oxide of from about 2 to about 4 wt. %.

4. The method according to claim 1, wherein the step of contacting includes contacting the biomass-derived pyrolysis oil with the first deoxygenating catalyst that comprises molybdenum in an amount calculated as an oxide of from about 10 to about 20 wt. %.

5. The method according to claim 1, wherein the step of contacting includes contacting the biomass-derived pyrolysis oil with the first deoxygenating catalyst that comprises the neutral catalyst support selected from the group consisting of a titanium oxide (TiO₂) support, a zirconium oxide (ZrO₂) support, a niobium oxide (Nb₂O₅) support, a theta alumina support, and combinations thereof.

6. The method according to claim 1, wherein the step of contacting includes contacting the biomass-derived pyrolysis oil with the first deoxygenating catalyst that comprises the neutral catalyst support selected from the group consisting of a titanium oxide (TiO₂) support and a zirconium oxide (ZrO₂) support.

7. The method according to claim 1, wherein the step of contacting includes contacting the biomass-derived pyrolysis oil with the first deoxygenating catalyst at the first predetermined hydroprocessing conditions that include a reaction temperature of from about 100 to about 400° C.

8. The method according to claim 1, wherein the step of contacting includes contacting the biomass-derived pyrolysis oil with the first deoxygenating catalyst at the first predetermined hydroprocessing conditions that include a pressure of from about 3,200 to about 12,400 kPa.

9. The method according to claim 1, wherein the step of contacting includes contacting the biomass-derived pyrolysis oil with the first deoxygenating catalyst at the first predetermined hydroprocessing conditions that include a liquid hourly space velocity of from about 0.25 to about 1 Hr⁻¹.

10. The method according to claim 1, further comprising the step of:
removing water from the first low-oxygen biomass-derived pyrolysis oil effluent to form a water-depleted low-oxygen biomass-derived pyrolysis oil effluent.

11. The method according to claim 10, wherein the first deoxygenating catalyst is contained in a first hydroprocessing reactor and the step of contacting includes introducing a feed stream containing the biomass-derived pyrolysis oil to the first hydroprocessing reactor, and wherein the method further comprises the step of:
combining at least a portion of the water-depleted low-oxygen biomass-derived pyrolysis oil effluent with the feed stream for introduction to the first hydroprocessing reactor.

12. The method according to claim 10, further comprising the step of:
contacting at least a portion of the water-depleted low-oxygen biomass-derived pyrolysis oil effluent with a second deoxygenating catalyst in the presence of hydrogen at second predetermined hydroprocessing conditions to form a second low-oxygen biomass-derived pyrolysis oil effluent.

13. The method according to claim 12, wherein the first deoxygenating catalyst is contained in a first hydroprocessing reactor and the step of contacting includes introducing a feed stream containing the biomass-derived pyrolysis oil to the first hydroprocessing reactor, and wherein the method further comprises the step of:
combining at least a portion of the second low-oxygen biomass-derived pyrolysis oil effluent with the feed stream for introduction to the first hydroprocessing reactor.

14. A method for deoxygenating a biomass-derived pyrolysis oil, the method comprising the step of:
introducing hydrogen and a feed stream comprising the biomass-derived pyrolysis oil to a first hydroprocessing reactor containing a first deoxygenating catalyst and that is operating at first predetermined hydroprocessing conditions to form a first low-oxygen biomass-derived pyrolysis oil effluent, wherein the first deoxygenating catalyst comprises a neutral catalyst support, nickel, cobalt, and molybdenum, and wherein the first deoxygenating catalyst comprises nickel in an amount calculated as an oxide of from about 0.1 to about 1.5 wt. %, cobalt in an amount calculated as an oxide of from about 2 to about 4 wt. %, molybdenum in an amount calculated as an oxide of from about 10 to about 20 wt. %, and the neutral catalyst support is selected from the group consisting of a titanium oxide (TiO₂) support, a zirconium oxide (ZrO₂) support, a niobium oxide (Nb₂O₅) support, a theta alumina support, and combinations thereof.

15. The method according to claim 14, wherein the step of introducing includes operating the first hydroprocessing reactor at the first predetermined hydroprocessing conditions including a reaction temperature of from about 100 to about 400° C., a pressure of from about 3,200 to about 12,400 kPa, and a liquid hourly space velocity of from about 0.25 to about 1 Hr⁻¹.

16. The method according to claim 14, further comprising the step of:
introducing the first low-oxygen biomass-derived pyrolysis oil effluent to a separator unit to remove water and form a water-depleted low-oxygen biomass-derived pyrolysis oil effluent.

17. The method according to claim 16, further comprising the step of:
combining at least a portion of the water-depleted low-oxygen biomass-derived pyrolysis oil effluent with the feed stream for introduction to the first hydroprocessing reactor.

18. The method according to claim 16, further comprising the step of:
introducing at least a portion of the water-depleted low-oxygen biomass-derived pyrolysis oil effluent to a second hydroprocessing reactor containing a second deoxygenating catalyst and that is operating at second predetermined hydroprocessing conditions to form a second low-oxygen biomass-derived pyrolysis oil effluent.

19. The method according to claim 18, further comprising the step of:
combining at least a portion of the second low-oxygen biomass-derived pyrolysis oil effluent with the feed stream for introduction to the first hydroprocessing reactor.

20. A catalysts for deoxygenating a biomass-derived pyrolysis oil, the catalyst comprising:
a neutral catalyst support, nickel, cobalt, and molybdenum, and wherein nickel is in an amount calculated as an oxide of from about 0.1 to about 1.5 wt. %, cobalt is in an amount calculated as an oxide of from about 2 to about 4 wt. %, molybdenum is in an amount calculated as an oxide of from about 10 to about 20 wt. %, and the neutral catalyst support is selected from the group consisting of a titanium oxide (TiO₂) support, a zirconium oxide (ZrO₂) support, a niobium oxide (Nb₂O₅) support, a theta alumina support, and combinations thereof.
